(19) United States
(12) Patent Application Publication
(10) Pub. No.: US 2012/0079533 A1
(43) Pub. Date: Mar. 29, 2012

(54) TECHNIQUES FOR DEVELOPING A CUSTOMIZED TELEVISION USER INTERFACE FOR A SECONDARY DEVICE

(75) Inventors: Ling Jun Wong, Escondido, CA (US); True Xiong, San Diego, CA (US)

(73) Assignee: SONY CORPORATION, Tokyo (JP)

(21) Appl. No.: 12/894,120

(22) Filed: Sep. 29, 2010

(51) Int. Cl. H04N 5/445

(52) U.S. Cl. 725/37

(57) ABSTRACT

Techniques for developing a television user interface for a secondary device include selecting a set of user interface rules from one or more pre-defined user interface rules, and selecting a set of user interface objects from one or more pre-defined user interface objects. The set of user interface rules are applied to the set of user interface objects to create a mapping between the inputs and outputs of a user interface of the secondary device to television remote control commands.

### BACKGROUND OF THE INVENTION

As technology continues to progress the television is no longer what it was before. New televisions are offering features beyond what the conventional television remote control can support. For example, a number of features provided by new televisions are best interacted with utilizing a keyboard. Without a convenient way of keying alpha/numeric characters, the television is limited to applications that the user can conveniently interface with utilizing short text inputs. Even using a conventional keyboard, a user may not be able to enter inputs in a language different from the language that the keyboard is configured in. For example, a user having a keyboard with English language keys cannot perform a search in a language such as Mandarin.

Television manufacturers currently have to develop and manufacture new dedicated remote controllers to support new television features that previous remote controls cannot support. In addition, the user has little or no ability to customize the remote controller. Accordingly, there is a continuing need for improved television remote controllers that can support new features as they are added to televisions and can support manufacturer and/or user customization.

### SUMMARY OF THE INVENTION

The present technology may best be understood by referring to the following description and accompanying drawings that are used to illustrate embodiments of the present technology that are directed toward techniques for developing a television user interface on a secondary device.

In one embodiment, a method includes accessing a plurality of pre-defined user interface rules and selecting a set of user interface rules there from. The method also includes accessing a plurality of user interface objects and selecting a set of user interface objects. The set of user interface rules are applied to the set of user interface objects. A mapping between the inputs and output of the user interface object to commands is also created according to the user interface rules. The method enables users to customize a user interface on an extendable computing device for controlling a television and/or content accessible through the television.

In another embodiment, a system includes an extendable computing device and a development computing device. The extendable computing device, such as smart phone, cellular phone, personal digital assistant, handheld gaming device, game console, netbook, ebook reader, tablet computer, laptop computer, portable music player, portable video player, or the like, includes a configurable user interface. The development computing device including a television user interface tool adapted for a user to select a set of user interface rules from a plurality of pre-defined user interface rules, a user to select a set of interface objects of the configurable user interface from a plurality of pre-defined interface objects, to apply the set of user interface rules to the plurality of user interface objects, and create a mapping between the input and output of the user interface objects to television remote control commands according to the set of user interface rules.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of an exemplary operating environment for embodiments of the present technology.

FIG. 2 shows a block diagram of an extendable computing device adapted to the control television and a computing device for developing the extendable computing device, in accordance with one embodiment of the present technology.

FIG. 3 shows a flow diagram of a method of configuring and setting up an extendable computing device to control a television, in accordance with one embodiment of the present technology.

FIG. 4 shows a flow diagram of a method of configuring and setting up an extendable computing device to control a television, in accordance with another embodiment of the present technology.

FIG. 5 shows a flow diagram of a method of controlling a television using an extendable computing device, in accordance with one embodiment of the present technology.

FIG. 6 shows a flow diagram of a method of providing data from the television for viewing on the extendable computing device, in accordance with one embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that all of these terms are to be interpreted as referencing physical manipulations and quantities and are merely convenient labels and are to be interpreted further in view of terms commonly used in the art. Unless specifically stated otherwise, as apparent from the following discussion, it is understood that through discussions of the present technology, discussions utilizing the terms such as “receiving,” and/or the like, refer to the actions and processes of an electronic device such as an electronic computing device that manipulates and transforms data. The data are represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects.

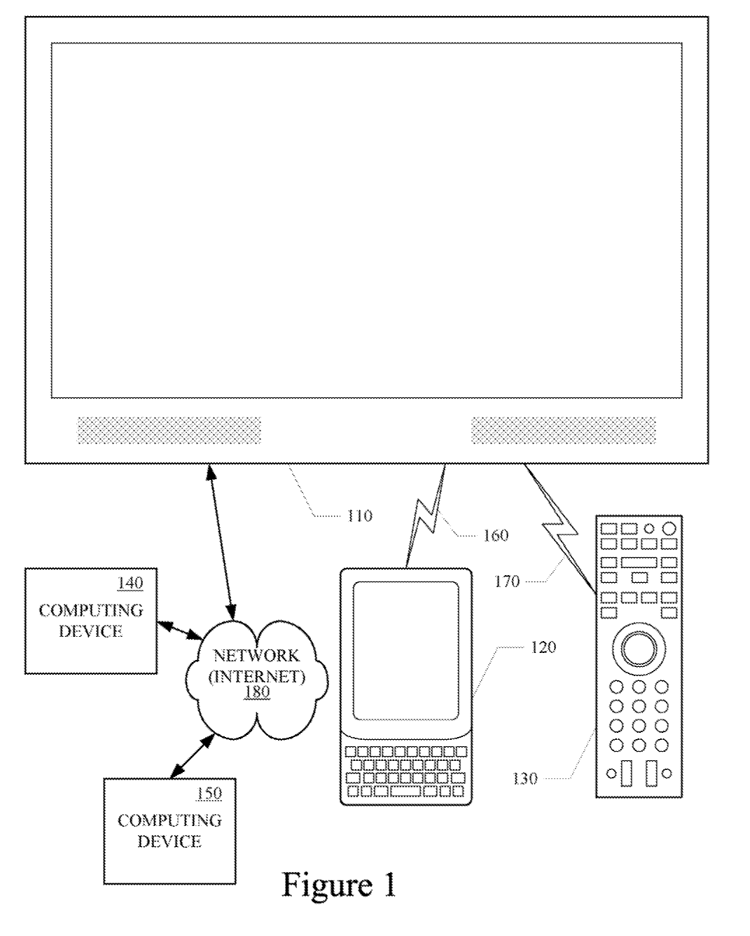

Referring now to FIG. 1, an exemplary operating environment for embodiments of the present technology is illustrated. The operating environment includes a television 110 and an extendable computing device 120 having a configurable user interface. The term extendable computing device, as used herein, is a computing device that provides one or more primary functions other than a conventional television remote control 130. The extendable computing device 120 may be a smart phone, cellular phone, personal digital assistant, handheld gaming device, game console, netbook, ebook reader, table computer, laptop computer, portable music player, portable video player, or the like. The operating environment may also include a conventional television remote control 130 and/or one or more other computing devices 140, 150. The extendable computing device 120, conventional remote control 130 and/or one or more other computing devices 140, 150 may be communicatively coupled to the television 110 by one or more communication links 160, 170 and/or networks 180. The communication links 160, 170 may be wired and/or wireless communication links. The networks 180 may include local area networks (LAN) such as home network, wide area networks (WAN) such as a cable or satellite entertainment network, the interne, and/or the like. In one implementation, the extendable computing device 120, and optionally the conventional remote control 130, may be communicatively coupled to the television 110 by a remote control communication link such as a Sony Integrated Remote Control System (SIRCS) link.

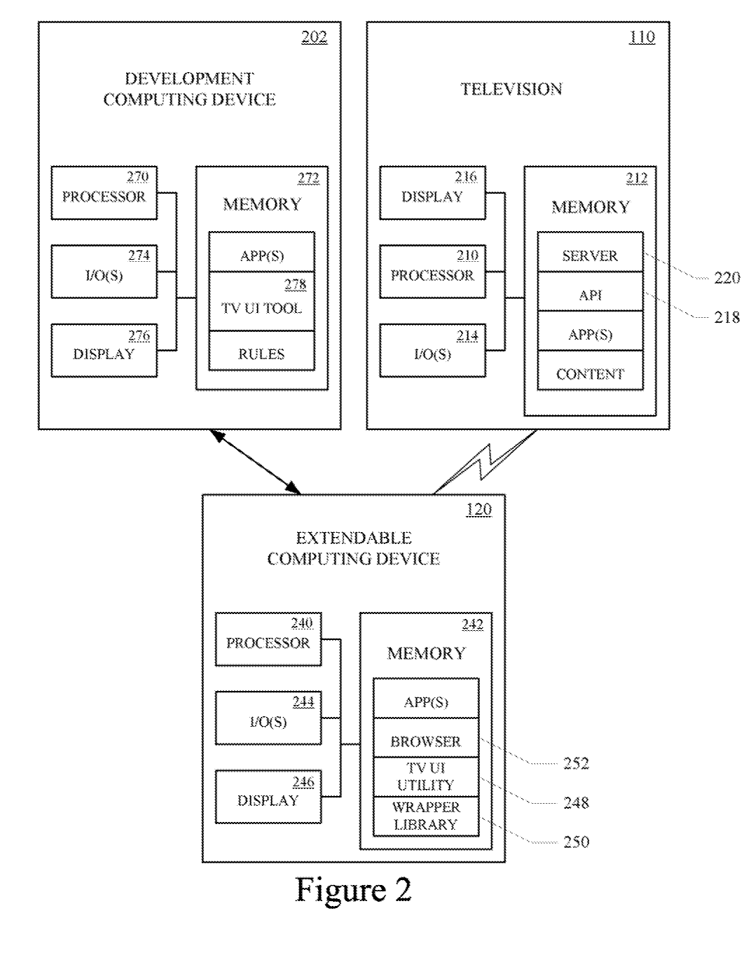

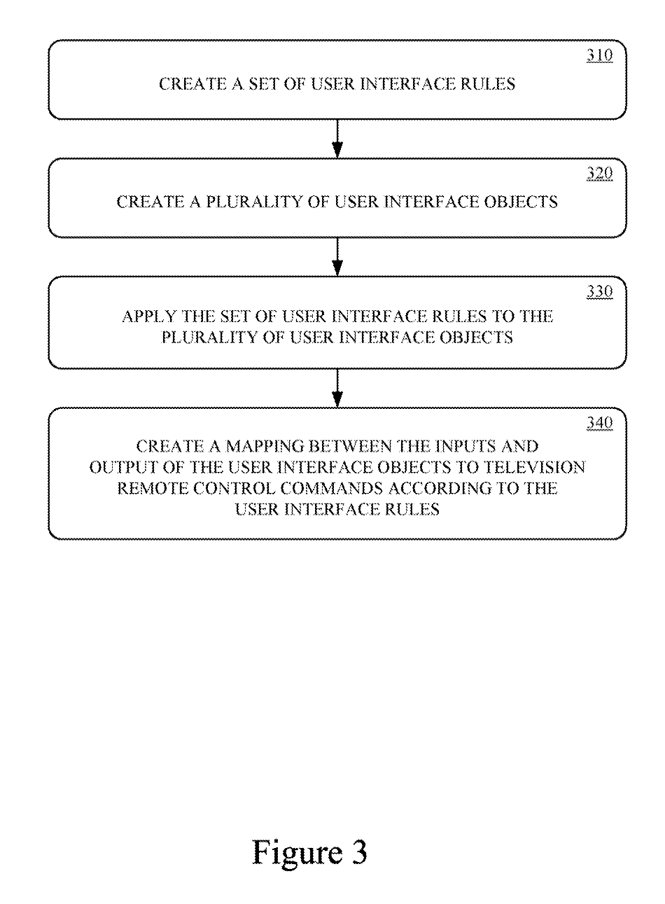

The configuration and operation of the television 110 and extendable computing device 120 will be further explained with reference to FIGS. 2 and 3. In FIG. 2, the extendable computing device 120 is adapted to control the television 110. In one implementation, the extendable computing device 120 may be communicatively coupled to another computing device 202 for developing a customized user interface for controlling the operation of the television 110.

The television 110 may include a processor 210, memory 212, and a plurality of input/output interfaces 214 such as a display 216, communication ports, control panel, and the like. The extendable computing device 120 may include a processor 240, memory 242, and a plurality of input/output interfaces 244 such as a touch screen display 246, communication ports, keyboard, mouse, accelerometer and/or the like. The development computing device 202 may include a processor 270, memory 272, and a plurality of input/output interfaces 274 such as a display 276, communication ports, keyboard, mouse and the like.

In the development computing device 202, the processor 270 executes one or more sets of computing device executable instructions (e.g., software programs, routines, drivers) to implement one or more applications, tools, utilities, scripts and the like and create and/or manipulate one or more data structures such as files, tables, databases, registries, libraries, and/or the like. In particular, the processor 270 of the development computing device 202 includes a television user interface design tool 278 for adapting any of a plurality of extendable computing devices 120, such as a smart phone, cellular phone, personal digital assistant, handheld gaming device, game console, netbook, ebook reader, tablet computer, laptop computer, portable music player, portable video player, or the like, to control the television 110.

The television user interface design tool 278 may be utilized to adapt one or more input/output interfaces 244, 246 of the extendable computing device 120 to operate as a user interface for controlling a television 110. In one implementation, the television user interface design tool 278 creates a television user interface utility 248 and a wrapper library 250 which are loaded onto the extendable computing device 120. The television user interface utility 248 controls one or more input/out interfaces 244, including the display 246, of the extendable computing device 120 as a user interface for controlling operation of the television 110. In one implementation, the television user interface utility 248 may generate a virtual key pad on the display 246 of the extendable computing device 120 to implement content presentation controls such as play, pause, rewind, and fast forward. Similarly other virtual keys may implement content source controls such as cable, satellite, DVD player, and/or antenna selection keys. In another implementation, the television user interface utility 248 may configure the outputs of an accelerometer in the extendable computing device 120 to implement navigation controls such as scroll up, down, left and right in response to the extendable computing device 120 being tilted back, forward, left and right. In such case, the display 246 of the extendable computing device 120 may be configured by the television user interface utility 248 to display a navigable list of information that may be manipulated in response to the navigation control input from the accelerometer. In yet another implementation, a physical QWERTY key pad of the extendable computing device 120 may be configured by the television user interface utility 248 for data entry using the extendable computing device 120. In yet another implementation, the television user interface utility 248 may generate a virtual keyboard on the display 246 of the extendable computing device 120 to implement a virtual keyboard for a selected language, such as French, German, Mandarin or the like. In yet another implementation, a speech to command/text application of the extendable computing device 120 may be configured by the television user interface utility 248 to receive voice inputs from a user and convert them to commands for controlling the television 110 and/or inputting text thereto.

In one implementation, the television user interface utility 248 may execute within a browser application 252 of the extendable computing device or interface with the browser 252 to provide outputs and/or receive inputs on the display screen 246 of the extendable computing device 120 related to controlling the television 110 and/or manipulating information and/or content associated with the television 110. In another implementation, the television user interface utility 248 may instead be implemented as a separate application on the extendable computing device 120 to control the television 110 and/or manipulating information and/or content associated with the television 110. In one implementation, the television user interface design tool 278 of the development computing device 202 can be accessed to configure and download the television user interface utility 248 to the extendable computing device 120 utilizing the browser 252 of the extendable computing device 120.

The wrapper library 250 receives commands generated in response to user activation of one or more input/output interfaces 244, 246 of the extendable computing device 120 and converts them to television remote control commands of a standard protocol, such as SIRCS commands. The television remote control commands may be received by an application programming interface (API) 218 of the television 110. In one implementation, the API 218 may be provided by a server module 220 of the television 110. In one implementation, the server 220 exists on the home network and is inaccessible outside the network, that is, it is closed to the internet. The API 218 may queue the remote control commands, generated in response to manipulation of the user interface on the extendable computing device 120, just like they were received from a conventional television remote control 120. Similarly, television remote control commands received by the extendable computing device 120 from the television 110 are converted by the wrapper library 250 to one or more commands for controlling one or more input/output interfaces 244, 246 of the extendable computing device 120. In one implementation, the television user interface design tool of the development computing device can be accessed to configure and download the wrapper library 250 to the extendable computing device 120 utilizing the browser 252 of the extendable computing device 120.

The television user interface utility 248 may also send and receive user interface information in HyperText Transfer Protocol (http) request, HyperText Markup Language (HTML), eXtensible Markup Language (XML), or the like. In one implementation, information in an XML file or the like may include data, and parameters such as layout, font, color and the like for displaying the information as part of the user interface on the extendable computing device 120 for controlling the television 110. In another implementation, the XML file may include data input on the television user interface of the extendable computing device 120.

The television user interface design tool 278 advantageously enables developers to create custom user interface on an extendable computing device 120 for controlling a television 110 and/or content accessible through the television 110. Accordingly embodiments of the present technology improve the user experience while reducing hardware costs of the television 110. The television manufacturer advantageously does not have to create new dedicated remote controllers to keep up with technological innovations. Instead, technological innovations of computing devices such as, smart phones, cellular phones, personal digital assistants, handheld gaming devices, game consoles, netbooks, ebook readers, tablet computers, laptop computers, portable music players, portable video players, or the like, can be utilized in a user interface to control televisions 110. Similarly, a television user can have control over the design of the remote controller interface for their television.

It is appreciated that many other devices and/or subsystems (not shown) may be connected to the television 110, extendable computing device 120, and/or development computing device 202. Conversely, all of the devices shown in FIGS. 1 and 2 need not be present to practice the present technology. The devices and subsystem can also be interconnected in different way from that shown in FIGS. 1 and 2.

Referring now to FIG. 3, a method of configuring and setting up an extendable computing device to control a television, in accordance with one embodiment of the present technology, is shown. The method may be implemented as computing device-executable instructions (e.g., computer program) that are stored in computing device-readable media (e.g., computer memory) and executed by a computing device (e.g., processor).

The method may begin with creating a set of user interface rules, at 310. In one implementation, the set of user interface rules include application-server communication rules. In one implementation, creating a set of user interface rules includes specifying one or more parameters and/or one or more variables for one or more rules. At 320 a plurality of user interface objects for the extendable computing device are created. The creation of user interface objects include specifying the user interface elements, such as display, touch screen, key pad, microphone, accelerometer and/or the like. The creation of user interface objects also includes specifying the inputs and outputs (e.g., actions) of the user interface elements and/or the like. In one implementation, user interface objects for graphical user interface may also be placed. Placing user interface objects may include specifying the organization of the objects and one or more attributes of one or more user interface objects. In one implementation, specifying one or more attributes may include choosing an image, the size, colors, fonts, animations and/or the like of one or more objects.

At 330, the set of user interface rules are applied to the user interface objects. At 340, a wrapper library is created mapping the inputs and/or outputs of the user interface objects to television remote control commands of a standard protocol, according to the applicable user interface rules. In one implementation, the wrapper library maps the input and/or outputs of the user interface objects to corresponding SIRCS commands.

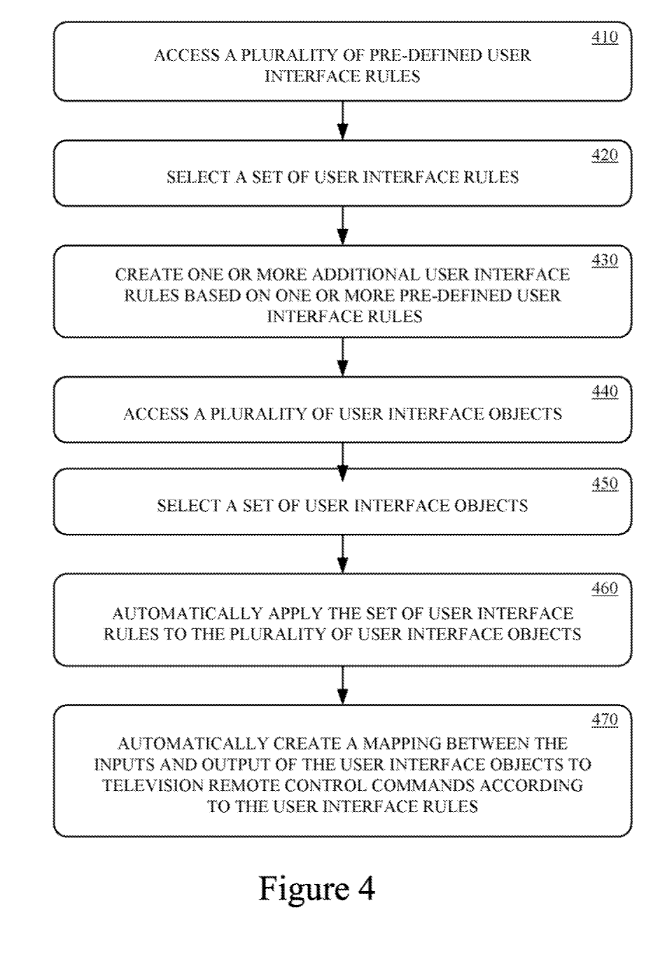

Referring now to FIG. 4, a method of configuring and setting up an extendable computing device to control a television, in accordance with another embodiment of the present technology, is shown. The method may again be implemented as computing device-executable instructions (e.g., computer program) that are stored in computing device-readable media (e.g., computer memory) and executed by a computing device (e.g., processor).

The method may begin with accessing a plurality of pre-defined user interface rules, at 410. In one implementation, the plurality of pre-defined user interface rules include application-server communication rules. The application server communication rules take care of the API handling. At 420, a set of user interface rules are selected from the pre-defined user interface rules. In one implementation one or more rules are automatically selected for the set of user interface rules. In addition or alternatively, one or more of the rules may be selected by the user. In one implementation, the pre-defined rules include one or more parameters and/or one or more variables. The parameters and/or variables may be pre-defined or specified by the user when selected, depending upon the rule.

For example, one or more rules for configuring the server's IP address and network port are automatically selected. In another example, a user may select one or more rules that define commands that are generated from the outputs of an accelerometer of the extendable computing device. In yet another example, the user may select one or more rules that define generation of an http request including the entered data generated from outputs of a keyboard. The selected rules for the keyboard may include one or more parameters and/or variables for selecting the language for the keyboard and the corresponding key layout. In yet another example, a user may select rules for requesting a list of metadata of the current activity shown on the television. The list could be a Bravia Internet Video Link (BIVL) asset list, a list of TV channels from an electronic television guide, or a list of settings from a television configuration setup page. The user can select a rule for each of these unique functions that correspond to the television API for controls and a variable for functions that are not unique. For example, getting a list of current offerings on the television is a unique function. However, the number of assets to get each time may be determined by the user.

At optional process 430, one or more additional user interface rules are defined based on one or more of the plurality of pre-defined user interface rules. For example, an additional rule may be created to call the following basic rules of “up” and “enter” to generate the sequence of commands in an http request to the server on the TV. In another example, an additional rule could include “get a list of television channels” and “get a list of BIVL services” to generate an http request to get a list of television channel and BIVL services.

At 440, a plurality of user interface objects are accessed. The user interface objects may be accessed based on the selected set of user interface rules. The user interface objects specify user interface elements, such as display, touch screen, key pad, microphone, accelerometer and/or the like. The user interface objects also specifying the inputs and outputs (e.g., actions) of the user interface elements and/or the like. At 450, a set of user interface objects are selected. The user interface objects for graphical user interfaces are also placed by the user when selected. In one implementation, placing user interface objects may include specifying the organization of the objects and one or more attributes of one or more user interface objects. In one implementation, specifying one or more attributes may include choosing an image, the size, colors, fonts, animations, sound effects, and/or the like of one or more objects.

At 460, the set of user interface rules are applied to the user interface objects' actions. Examples of object actions are “OnClick,” “OnSuccess,” OnFailure,” “OnHover” and the like. “OnClick” and “OnHover” would mean what rules to perform when the object is selected. Certain rules may have the user define what to do with the result that has been returned. In another example, a “GetList” rule may return a list of results. The user will determine how the list should look when the results are returned. For instance, where each image and the corresponding metadata should be placed, the size of the image, and/or the like. Based on a returned error code, the user may define the action and what to show on the display when something failed. For example, “OnSuccess” would refer to what has to be done when the request is successfully transmitted. “OnFailure” refers to the actions to be done when the http request has failed.

At 470, a wrapper library is created mapping the inputs and/or outputs (e.g., actions) of the user interface objects to television remote control commands of a standard protocol, according to the applicable user interface rules. In one implementation, the wrapper library maps the input and/or outputs of the user interface objects to corresponding SIRCS commands.

Embodiments of the present technology advantageously enables non-technical users to readily create a customized user interface on their extendable computing device for use as a controller for the television, cable box, satellite receiver, digital video recorder, digital video disk player and/or the like. The pre-defined rules take care of the API handling so that the user generally only needs to graphically manage the television user interface.

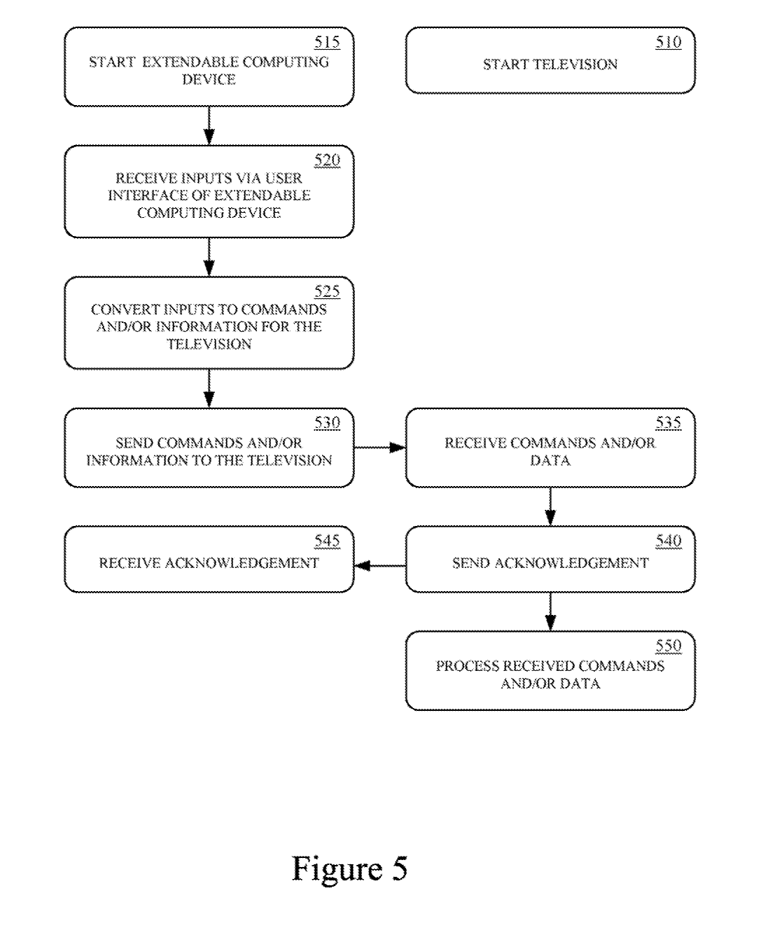

Referring now to FIG. 5, a method of controlling a television using an extendable computing device, in accordance with one embodiment of the present technology, is shown. The method may again be implemented as computing device-executable instructions (e.g., computer program) that are stored in computing device-readable media (e.g., computer memory) and executed by a computing device (e.g., processor).

The method may begin with starting up a television, at 510, and an extendable computing device adapted to control a television, at 515. In one implementation, upon boot up of the television, a server and/or API is initialized. Similarly, a television user interface utility and wrapper library on the extendable computing device is initialized. At 520, one or more inputs are received via the user interface of the extendable computing device. At 525, the one or more inputs are converted to commands and/or information for use by the television. In one implementation, the actions are converted into SIRCS commands and/or information in http requests. At 530, the extendable computing device sends the commands and/or information, using one or more standard communication protocols, to the television. In one implementation, the extendable computing device sends commands to the television as SIRCS commands. In one implementation, the extendable computing device sends information, such as text strings, to the television in an http, XML or the like request.

At 535, the commands and/or information is received by the television. At optional process 540, the television may send an acknowledgement of receipt of the command and/or information back to the extendable computing device. In such case, the acknowledgement may be received by the extendable computing device, at 545.

At 550, the television processes the received commands and/or data. In one implementation, the SICRS commands and/or information in the XML files are passed by the API 218 into a SIRCS queue and/or one or more applications on the television 212 for respective processing.

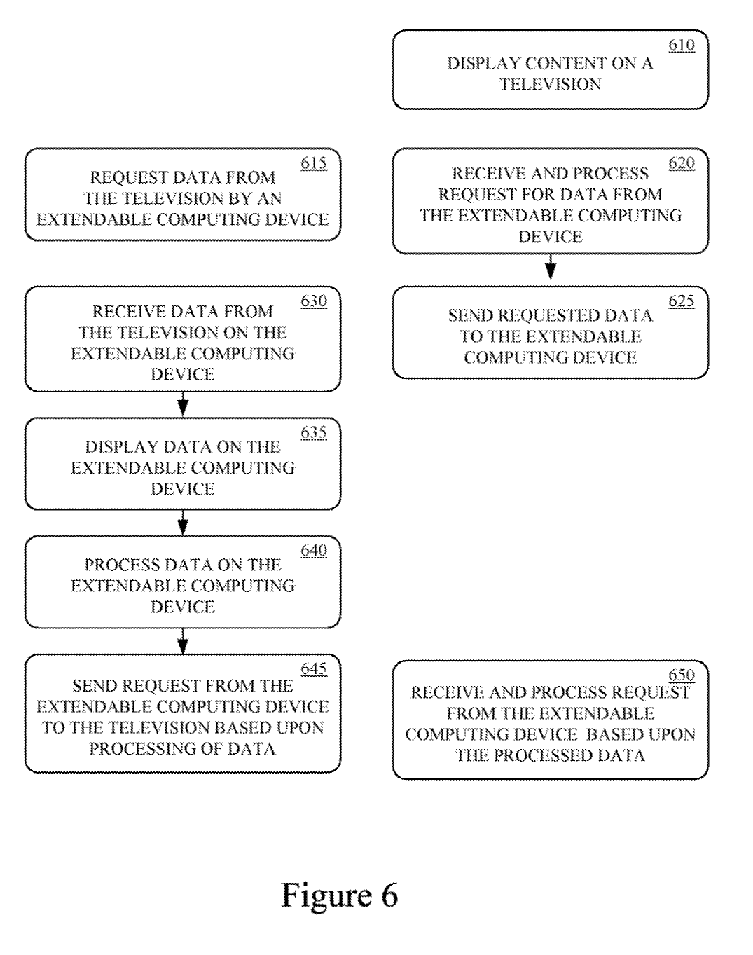

Referring now to FIG. 6, a method of providing data from the television for viewing on the extendable computing device, in accordance with one embodiment of the present technology, is shown. The method may again be implemented as computing device-executable instructions (e.g., computer program) that are stored in computing device-readable media (e.g., computer memory) and executed by a computing device (e.g., processor).

The method may begin with displaying content on a television, at 610. At 630, data concerning or one or more items of content on the television and or functions of the television is received by the extendable computing device. In one implementation, the data is received from the television across a remote control communication channel such as a SIRCS communication channel. In one implementation, the data may include metadata about the content. The metadata may be content summaries (e.g., title, actors, director, previews, reviews), play lists and/or the like. In another implementation, the data may be functions available through the television, such as selection of content sources, presentation controls, configuration settings, and/or the like.

The data may be received in response to a request. For example, the data may be requested from the television by the extendable computing device, at optional process 615. The request may include a target module of the television, a size of a list block, an offset in the list, and/or the like. In one implementation, the request may be an http request including information and/or specifications of the request. At optional process 620, the request for the data is received and processed by the server of the television. In one implementation, the server on the television processes the request and passes the information to a current active module. The current active module returns the request data in the form of an XML file, or the like, based on the specifications of the request. There may be an asset identifier associated with each set of data for identification purposes. At optional process 625, the requested data is sent from the server of the television to the extendable computing device. In one implementation, the data is sent to the extendable computing device in an XML file or the like.

At 63, the data is displayed on the extendable computing device substantially while content is being displayed on the television. At 640, the metadata may be processed in response to manipulation of the user interface of the extendable computing device. In one implementation, the navigation of a list may depend upon the implementation of the television user interface utility on the extendable computing device. For example, on a touch screen enabled smart phone or tablet computer, navigation may be performed in response to corresponding swipe motions and taps detected on the touch screen. On a laptop, navigation may be performed in response to corresponding activations of a pointing device (e.g., mouse). At 645, a request may be sent from the extendable computing device to the television may be sent based upon manipulation of the data. In one implementation, the inputs generated by manipulation of the user interface to process the metadata may be converted into one or more commands and/or information for use by the television. The commands and/or information may be sent using a standard protocol such as SIRCS for commands and HTML, XML or the like for the information. In one implementation, the request may be a selection of an asset. In another implementation, the request may be a selection of an item of content to be played on the computing device. In yet another implementation, the request may be a selection of an item to be added to a play list. In yet another implementation, the request may be a transaction to rent or purchase an item of content. The request may include information on the target module of the television as well as a corresponding asset identifier, content identifier and/or the like. At 650, the request based on processing of the data on the extendable computing device is received by the television. In one implementation, the server, upon receipt of the request, passes the information to the target module. The target module acts accordingly to play or queue the content, select the asset, and/or the like. Various processes 610-650 may be iteratively performed to implement one or more functions. For example, various processes 610-650 may be iteratively performed to select content from a catalog, complete a transaction to rent or purchase the content, add the content to a play list, watch the content, write a review of the content, and/or the like.

Accordingly, embodiments of the present technology, also enable a user to view and process data concerning function's of a television and/or content available through the television on a secondary device while content is being played on the television so that the viewing experience is not interrupted by the processing of related data on the secondary computing device.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A method comprising:
accessing a plurality of pre-defined user interface rules;
selecting a set of user interface rules;
accessing a plurality of user interface objects
selecting a set of user interface objects;
applying the set of user interface rules to the set of user interface objects; and
creating a mapping between the inputs and outputs of the set of user interface objects to commands according to the set of user interface rules.

2. The method of claim 1, further comprising:
creating one or more additional user interface rules based on one or more pre-defined user interface rules;
applying the one or more additional user interface rules to the set of user interface objects; and
creating a mapping between the inputs and output of the set of user interface objects to commands further according to the one or more additional user interface rules.

3. The method of claim 2, further comprising:
receiving one or more inputs from a user interface of an extendable computing device;
converting the one or more inputs into one or more commands for a television using the mapping; and
sending the one or more commands to the television.

4. The method of claim 3, further comprising:
converting the one or more input into information for the television; and
sending the information to the television.

5. The method of claim 3, wherein the set of user interface objects specifying user interface elements and specifying inputs of the user interface elements.

6. The method of claim 5, wherein selecting the set of user interface objects further comprises:
placing one or more of the user objects; and
specifying one or more attributes of one or more user interface objects.

7. The method of claim 6, wherein specifying one or more attributes of one or more user interface objects comprises one or more of choosing an image, a size, a color, a font, an animation of one or more of the user interface objects.

8. One or more computing device readable media having computing device executable instructions which when executed perform a method comprising:
selecting a set of user interface rules from one or more pre-defined user interface rules;
selecting a set of user interface objects from one or more pre-defined user interface objects; and
applying the set of user interface rules to the set of user interface objects to create a mapping between the inputs and outputs of a user interface of an extendable computing device to television remote control commands.

9. The one or more computing device readable media having computing device executable instructions which when executed perform the method of claim 8, wherein selecting the set of user interface objects further comprises:
placing one or more of the user objects; and
specifying one or more attributes of one or more user interface objects.

10. The one or more computing device readable media having computing device executable instructions which when executed perform the method of claim 8, further comprising:
creating one or more additional user interface rules based on one or more pre-defined user interface rules;
applying the one or more additional user interface rules to the set of user interface objects; and
creating a mapping between the inputs and output of the set of user interface objects to commands further according to the one or more additional user interface rules.

11. The one or more computing device readable media having computing device executable instructions which when executed perform the method of claim 10, wherein selecting the set of user interface objects further comprises:
placing one or more of the user objects; and
specifying one or more attributes of one or more user interface objects.

12. A system comprising:
an extendable computing device including a configurable user interface; and
a development computing device including a television user interface tool to select a set of user interface rules from a plurality of pre-defined user interface rules, selecting a set of interface objects of the configurable user interface from a plurality of pre-defined interface objects, to apply the set of user interface rules to the plurality of user interface objects and create a mapping between the input and output of the user interface objects to television remote control commands according to the set of user interface rules.

13. The system according to claim 12, wherein extendable computing device is a smart phone, cellular phone, personal digital assistant, handheld gaming device, game console, netbook, ebook reader, tablet computers, laptop computer, portable music player, or portable video player.

14. The system according to claim 12, wherein the configurable user interface includes a display.

15. The system according to claim 12, wherein the configurable user interface includes a touch screen.

16. The system according to claim 12, wherein the configurable user interface includes an accelerometer.

17. The system according to claim 12, wherein the configurable user interface includes a virtual keyboard implemented on a display.

18. The system according to claim 17, wherein the virtual keyboard is configurable to support any one of a plurality of languages.

19. The system according to claim 12, wherein the television user interface tool further creates a television user interface utility on the extendable computing device to implement the set of user interface rules applied to the plurality of user interface objects and creates a wrapper library on the extendable computing device to map the input and output of the user interface objects to television remote control commands according to the user interface rules.

20. The system according to claim 12, wherein:
the television user interface utility receives an input from the configurable user interface;
the wrapper library converts the inputs to a command or information for use by the television; and
the television user interface utility sends the command or information to the television.
